(19) United States
(12) Patent Application Publication
(10) Pub. No.: US 2013/0322071 A1
(43) Pub. Date: Dec. 5, 2013

(54) LAMP-STAND AND LAMP USING THE SAME

(71) Applicants: CAL-COMP ELECTRONICS & COMMUNICATIONS COMPANY LIMITED, New Taipei City (TW); KINPO ELECTRONICS, INC., New Taipei City (TW)

(72) Inventor: YI-WEI CHANG, New Taipei City (TW)

(73) Assignees: Kinpo Electronics, Inc., New Taipei City (TW); Cal-Comp Electronics & Communications Company Limited, New Taipei City (TW)

(21) Appl. No.: 13/749,694

(22) Filed: Jan. 25, 2013

(30) Foreign Application Priority Data
Jun. 1, 2012 (TW) 101119824

(51) Int. Cl. F21V 21/00; F21V 1/00

(52) U.S. Cl. CPC F21V 21/00; F21V 1/00
USPC 362/235; 362/382; 362/311.01

(57) ABSTRACT

A lamp including a lamp-stand, a lamp-shell and a lamp shade is provided. The lamp-stand has an assembling portion, a helix portion, an accommodation space and a plurality of dotting dents, the helix portion is located under the assembling portion, the accommodation space is located in the assembling portion and the helix portion, and the dotting dents are disposed surrounding the assembling portion. The lamp-shell has a thread portion and a plurality of pricks, in which the helix portion of the lamp-stand fits the helix portion of the lamp-shell by screwing, the pricks are pricked into the assembling portion and located in the dotting dents. The layout of the dotting dents enables the interference amount produced by the pricks pricked into the assembling portion is smaller, which is able to maintain the structure completeness of the lamp-stand and advance the assembling yield of the lamp employing the lamp-stand.

### CROSS-REFERENCE TO RELATED APPLICATION

This application claims the priority benefit of Taiwan application serial no. 101119824, filed on Jun. 1, 2012. The entirety of the above-mentioned patent application is hereby incorporated by reference herein and made a part of this specification.

### BACKGROUND OF THE INVENTION

1. Field of the Invention

The invention generally relates to a lamp-stand and a lamp, and more particularly, to a lamp-stand with advanced product yield and a lamp using the lamp-stand.

2. Description of Related Art

For assembling a lamp today, it mostly uses a lamp-assembling machine, under the associate actions of the cylinder, the pusher and other components of the lamp-assembling machine, multiple styluses of pins are pricked into the lamp-stand and helix portion of the lamp where the operation for using the styluses of a plunge tool to be pricked into the lamp-stand and helix portion of the lamp is referred as dotting process. The edge portion of the helix portion under the above-mentioned pricking action becomes a structure pricked in the lamp-stand so as to make the lamp-stand and the helix portion fixed by each other and effectively to advance the fixing effect between the lamp-stand and the helix portion of the lamp. After that, a welding process is used to form welding dots on the helix portion for electrically connection.

In more details, along with the development and applications of new materials, thermoplastic material with high conductivity and ceramic material both having harder and more brittle properties gradually have replaced the original plastic material with high toughness in the application field. At the time, during a dotting process, an excessive interference amount may destroy the lamp-stand, for example, the material gets broken, fracture or is too hard to be dotted. In this regard, it is urgent need to develop a new structure design to solve the above-mentioned problem.

### SUMMARY OF THE INVENTION

Accordingly, the invention is directed to a lamp-stand with new structure.

The invention is also directed to a lamp with structure completeness after a dotting process.

The invention provides a lamp-stand, which has an assembling portion, a helix portion, an accommodation space and a plurality of dotting dents, in which the helix portion is located under the assembling portion, the accommodation space is located in the assembling portion and the helix portion, and the dotting dents are disposed surrounding the assembling portion.

In an embodiment of the present invention, the above-mentioned dotting dents are not communicated with each other, and any two adjacent dotting dents have a distance from each other.

In an embodiment of the present invention, the above-mentioned lamp-stand further has an identifying structure disposed on at least the assembling portion for positioning itself with a fixture, and the identifying structure is a sunken indent or a groove extending to the helix portion.

In an embodiment of the present invention, the material of the above-mentioned lamp-stand is thermoplastic material with high conductivity or ceramic material.

The invention further provides a lamp, which includes a lamp-stand, a lamp-shell and a lamp shade, in which the lamp-stand has an assembling portion, a helix portion, an accommodation space and a plurality of dotting dents, the helix portion is located under the assembling portion, the accommodation space is located in the assembling portion and the helix portion, and the dotting dents are disposed surrounding the assembling portion. The lamp-shell has a thread portion and a plurality of pricks, in which the helix portion of the lamp-stand fits the helix portion of the lamp-shell by screwing, and the pricks are pricked into the assembling portion and located in the dotting dents.

In an embodiment of the present invention, the above-mentioned dotting dents of the lamp-stand are not communicated with each other, and any two adjacent dotting dents have a distance from each other.

In an embodiment of the present invention, the above-mentioned lamp-stand further has an identifying structure disposed on at least the assembling portion for positioning itself with a fixture. The identifying structure is a sunken indent or a groove extending to the helix portion.

In an embodiment of the present invention, the material of the above-mentioned lamp-stand is thermoplastic material with high conductivity or ceramic material.

In an embodiment of the present invention, the above-mentioned lamp further includes at least one light source located in the lamp shade and the light source is a light emitting diode (LED).

Based on the description above, in the lamp-stand and a lamp using the lamp-stand of the invention, due to disposing the dotting dents at the lamp-stand, after placing the lamp-shell and the lamp-stand together, the dotting process can be used on the corresponding dotting dents of the lamp-shell, so that the interference amount on the lamp-shell produced by the dotting process and thereby pricking into the lamp-stand is smaller than the conventional interference amount.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a lamp of the embodiment.

FIG. 2 is an exploded diagram of the lamp of FIG. 1.

FIG. 3 is a diagram showing the pricks of the lamp shade of FIG. 1 are pricked into the dotting dents of the lamp-stand.

### DESCRIPTION OF THE EMBODIMENTS

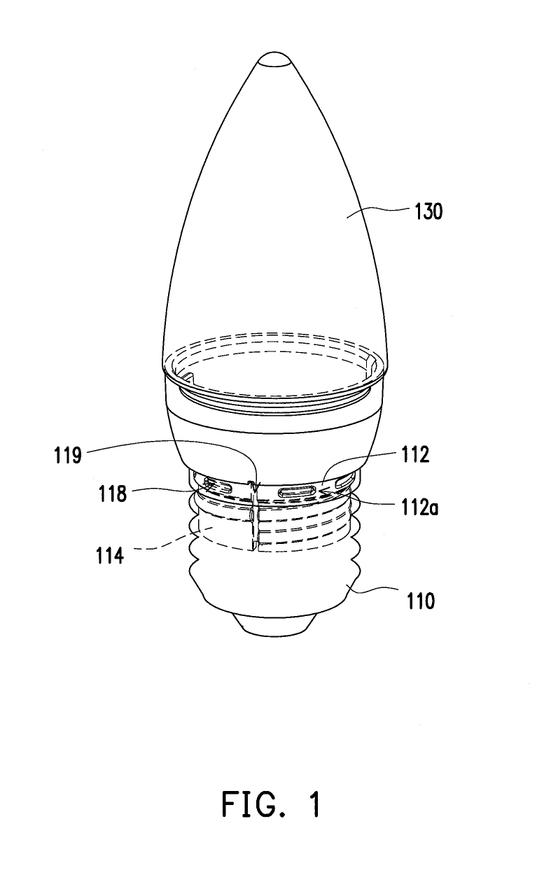

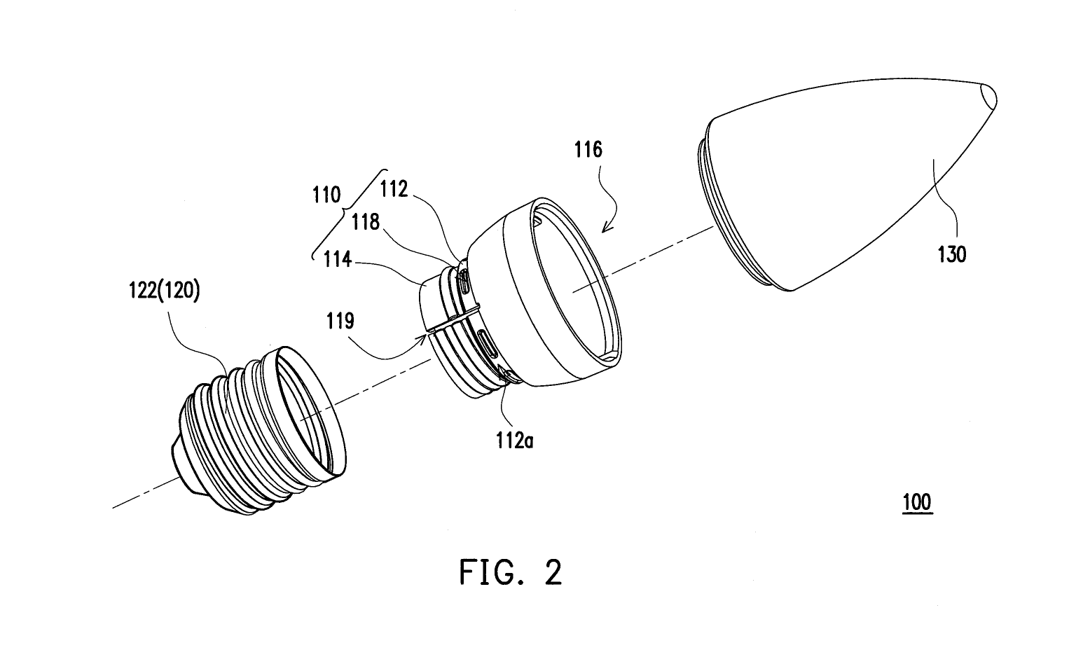

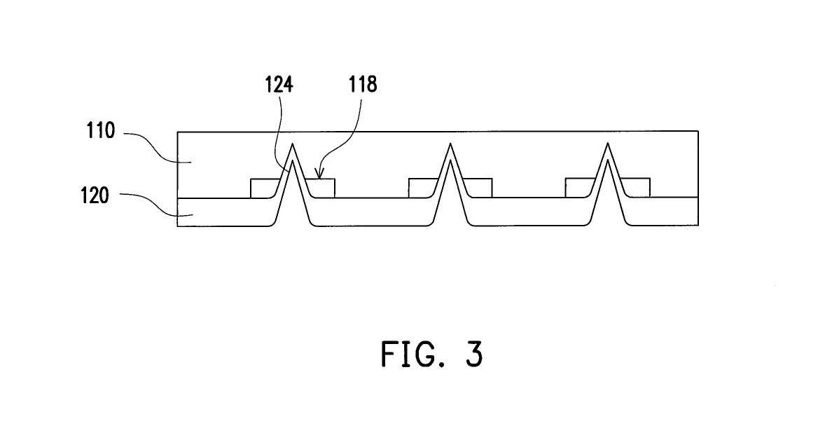

FIG. 1 is a schematic diagram of a lamp of the embodiment, FIG. 2 is an exploded diagram of the lamp of FIG. 1 and FIG. 3 is a partial cross-sectional diagram of the lamp of FIG. 1. Referring to FIGS. 1 and 2, a lamp 100 of the embodiment includes a lamp-stand 110, a lamp-shell 120 and a lamp shade 130, in which the lamp-stand 110 has an assembling portion 112, a helix portion 114, an accommodation space 116 and a plurality of dotting dents 118. The helix portion 114 is located under the assembling portion 112, the accommodation space 116 is located in the assembling portion 112 and the helix portion 114, and the accommodation space 116 is configured for accommodating a circuit board, wires or other components required by the lamp 100, which is omitted to describe. The dotting dents 118 are disposed surrounding the external surface 112a of the assembling portion 112, in which the dotting dents 118 are not communicated with each other, and any two adjacent dotting dents 118 have a distance from each other. The lamp-shell 120 has a thread portion 122 and a plurality of pricks 124, in which the helix portion 114 of the lamp-stand 110 fits the thread portion 122 of the lamp-shell 120 by screwing, while the pricks 124 are pricked into the assembling portion 112 and located in the dotting dents 118.

In the embodiment, the material of the lamp-stand 110 is thermoplastic material with high conductivity or ceramic material, and in comparison with the plastic material with high toughness selected by the lamp-stand in the prior art, the above-mentioned material has higher hardness and brittleness.

During fabricating the lamp 100 of the embodiment, first, the lamp-stand 110 is made in a mould (not shown), the lamp-stand 110 made by the mould (not shown) further has an identifying structure 119 for positioning itself with a fixture (not shown) and the identifying structure 119 is disposed at least on the assembling portion 112. The identifying structure 119 of the embodiment is a groove extending from the assembling portion 112 to the helix portion 114, but in other embodiments, the identifying structure 119 can be a sunken indent or have other shapes according to the need.

Next, the thread portion 114 of the lamp-stand 110 fits the thread portion 122 of the lamp-shell 120 by screwing. Then, the temporary assembly of the lamp-stand 110 and the lamp-shell 120 are placed in a dotting fixture (not shown) for conducting a dotting process, the identifying structure 119 is corresponding to the positioning structure (not shown) of the dotting fixture (not shown), and the positions of the pins (not shown) of the dotting fixture (not shown) are corresponding to the dotting dents 118 of the assembling portion 112 as well. After that, the pins (not shown) of the dotting fixture (not shown) are pricked into the lamp-shell 120. At the time, due to the pricking of the pins (not shown), the lamp-shell 120 produces a plurality of pricks 124 and the pricks 124 are pricked into the assembling portion 112 of the lamp-stand 110 and correspondingly located in the dotting dents 118.

In comparison with the prior art where the other portions of the assembling portion 112 having no dotting dents 118 are closer to the lamp-shell 120, in the embodiment, the bottoms of the dotting dents 118 are relatively far away from the lamp-shell 120 and thereby the interference amount produced by the pricks 124 which are pricked into the bottoms of the dotting dents 118 is not too much and the limited interference amount is not able to fragment the lamp-stand 110.

It should be noted that in the embodiment, the dotting dents 118 on the assembling portion 112 are not communicated with each other to form a groove. Instead, any two adjacent dotting dents 118 un-communicated with each other are spaced from each other. On the other hand, if a groove is disposed on the assembling portion 112 and surrounding the whole assembling portion 112 for dotting purpose, the portions of the assembling portion 112 with the disposed groove are thinner than the rest portions of the assembling portion 112, so that during the dotting process, the moment piercing force may cause the groove with a smaller and even thickness fragmented to make the whole lamp-stand 110 destroyed and no more usable. However, in the embodiment, the portions between any two adjacent dotting dents 118 on the assembling portion 112 are thicker than the rest portions of the assembling portion 112 where the dotting dents 118 are disposed, and the thicker portions are able to maintain the structure completeness of the lamp-stand 110 and prevent from being destroyed after the dotting process, which further advances the assembling yield of the lamp 100.

Thereafter, the light source is placed in the semi-finished product after assembling the lamp-stand 110 and the lamp-shell 120, followed by assembling the lamp shade 130 with the semi-finished product to finish the assembling process of the lamp 100. The type of the lamp 100 can be divided roughly as per the employed light source type, for example, the light source of the embodiment is light emitting diode (LED) and thus the lamp is an LED lamp. In other embodiments, the light source can be the traditional bulb or the light sources of other types.

In summary, in the lamp-stand and a lamp using the lamp-stand of the invention, due to disposing the dotting dents at the lamp-stand, the dotting process can be applied on the corresponding dotting dents of the semi-finished product of the lamp-shell and the lamp-stand and since the dotting dents are sunken into the external surface of the assembling portion, so that the interference amount produced by the pricks of the lamp-shell pricked into the lamp-stand is smaller, which is unable to make the lamp-stand fragmented, the structure completeness of the lamp-stand is kept and thereby the assembling yield of the lamp is advanced.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A lamp-stand, having an assembling portion, a helix portion, an accommodation space and a plurality of dotting dents, wherein the helix portion is located under the assembling portion, the accommodation space is located in the assembling portion and the helix portion, and the dotting dents are disposed surrounding the assembling portion.

2. The lamp-stand as claimed in claim 1, wherein the dotting dents are not communicated with each other, and any two adjacent dotting dents have a distance from each other.

3. The lamp-stand as claimed in claim 1, further having an identifying structure disposed on at least the assembling portion for positioning itself with a fixture.

4. The lamp-stand as claimed in claim 3, wherein the identifying structure is a sunken indent or a groove extending to the helix portion.

5. The lamp-stand as claimed in claim 1, wherein the material of the lamp-stand is thermoplastic material with high conductivity or ceramic material.

6. A lamp, comprising:
a lamp-stand, having an assembling portion, a helix portion, an accommodation space and a plurality of dotting dents, wherein the helix portion is located under the assembling portion, the accommodation space is located in the assembling portion and the helix portion, and the dotting dents are disposed surrounding the assembling portion;
a lamp-shell, having a thread portion and a plurality of pricks, wherein the helix portion of the lamp-stand fits the helix portion of the lamp-shell by screwing, the pricks are pricked into the assembling portion and located in the dotting dents; and
a lamp shade, assembled onto the lamp-stand.

7. The lamp as claimed in claim 6, wherein the dotting dents of the lamp-stand are not communicated with each other, and any two adjacent dotting dents have a distance from each other.

8. The lamp as claimed in claim 6, wherein the lamp-stand further has an identifying structure disposed on at least the assembling portion for positioning itself with a fixture.

9. The lamp as claimed in claim 8, wherein the identifying structure is a sunken indent or a groove extending to the helix portion.

10. The lamp as claimed in claim 6, wherein the material of the lamp-stand is thermoplastic material with high conductivity or ceramic material.

11. The lamp as claimed in claim 6, further comprising at least one light source located in the lamp-shell.

12. The lamp as claimed in claim 11, wherein the at least one light source is a light emitting diode (LED).
